(19) United States
(12) Patent Application Publication
(10) Pub. No.: US 2008/0056274 A1
(43) Pub. Date: Mar. 6, 2008

(54) Method and apparatus for dynamically maintaining a routing database for a SIP server

(76) Inventor: Joseph V. Mastrogiulio, Brooklyn, NY (US)

Correspondence Address: RYAN, MASON & LEWIS, LLP, 1300 POST ROAD, SUITE 205, FAIRFIELD, CT, 06824, US

(21) Appl. No.: 11/513,781

(22) Filed: Aug. 31, 2006

(51) Int. Cl. H04L 12/56

(52) U.S. Cl. 370/395.31; 370/409

(57) ABSTRACT

Methods and apparatus are provided for dynamically maintaining a routing database for a SIP server. A routing database is generated in a network by receiving a request message from a first user to contact a second user; forwarding the request message to a parent node in the network; receiving a message from the parent node containing a contact address for the second user; and storing the contact address for the second user in the routing database for future use. The request message can then be forwarded to a node associated with the second user based on the received contact address. The request message can be, for example, an invite message. The network can optionally be comprised of a plurality of SIP nodes. A routing database can also be generated in a network by receiving a request message from a node associated with a first user to contact a second user; obtaining a contact address for the second user; and forwarding a message containing the contact address for the second user to the node associated with the first user.

### FIELD OF THE INVENTION

The present invention relates generally to techniques for maintaining routing data, and more particularly, to the field of database replication mechanisms.

### BACKGROUND OF THE INVENTION

A network of Session Initiation Protocol (SIP) proxy servers typically requires run-time data for routing incoming SIP requests. Each SIP server in the network typically maintains a local database for storing its own local routing data. Some data needs to be available to all servers in the network. Typically, the nodes in a SIP network are interconnected in a hierarchical configuration. If a user associated with a first node desires to contact another user associated with a second node, the request is routed from the first node to an edge node in the hierarchy, which then routes the request to the second node. Of course, if there is a problem with the edge node, the request cannot be completed.

A number of techniques have been proposed or suggested for local storage of routing information at each SIP proxy. It can be a significant challenge, however, to statically configure all the data for all SIP proxies in the network. In particular, a significant amount of database space is required to store the routing information at each local node. In addition, a significant amount of time is required by a central administration system to provide all the data to all the nodes in the SIP infrastructure. In addition, each of the local databases requires a sophisticated system to keep all the databases up-to-date and to ensure the integrity of the data across all nodes. This approach, though sufficient for small SIP networks, does not scale well when deployed in larger SIP networks.

A need therefore exists for a more efficient way to dynamically create and maintain replicated databases at nodes in a SIP network. A further need exists for methods and apparatus for replicating databases at nodes in a SIP network without requiring a central administration system to provide all the data to all the SIP servers in the network.

### SUMMARY OF THE INVENTION

Generally, methods and apparatus are provided for dynamically maintaining a routing database for a SIP server. According to one aspect of the invention, a routing database is generated in a network by receiving a request message from a first user to contact a second user; forwarding the request message to a parent node in the network; receiving a message from the parent node containing a contact address for the second user; and storing the contact address for the second user in the routing database for future use. The request message can then be forwarded to a node associated with the second user based on the received contact address. The request message can be, for example, an invite message. The network can optionally be comprised of a plurality of SIP nodes.

According to another aspect of the invention, a routing database is generated in a network by receiving a request message from a node associated with a first user to contact a second user; obtaining a contact address for the second user; and forwarding a message containing the contact address for the second user to the node associated with the first user.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary network environment 100 in which the present invention can operate;

FIG. 2 illustrates the flow of information in the exemplary network environment of FIG. 1 according to an exemplary implementation of the present invention; and

FIG. 3 is a sample table for an exemplary routing database maintained by a branch proxy of FIG. 1.

### DETAILED DESCRIPTION

The present invention provides a mechanism that allows each server in a network to replicate its routing data dynamically (at run-time) by using a redirection mechanism. According to one aspect of the invention, a SIP redirect mechanism is employed to collect routing data at each node, such that the databases at each node are built dynamically at run time. In one exemplary implementation, each SIP server collects the routing data at run time that it receives by means of a SIP Redirect Response, such as a 302 final response, and stores the routing data in the local database of the SIP server for those endpoints that were previously accessed by the particular SIP server. Under the SIP protocol, the 3xx class of responses indicates a redirection of the call. In this manner, each database at each node is replicated to the extent of the usage of that particular node. If a SIP server has issued requests to 1,000 of all the 500,000 potential subscribers in the system, for example, then the database at that SIP server node contains routing data only for those 1,000 users that were previously accessed by the particular SIP server.

According to another aspect of the invention, faulty routing data is automatically updated. If a particular piece of routing data becomes obsolete, then the routing of requests based on that stale data would initially fail. The SIP server node re-issues the request to its parent node, which would then provide new routing data via another SIP Redirect Response, such as a 302 final response. This new routing data replaces the stale data that is updated with the current data.

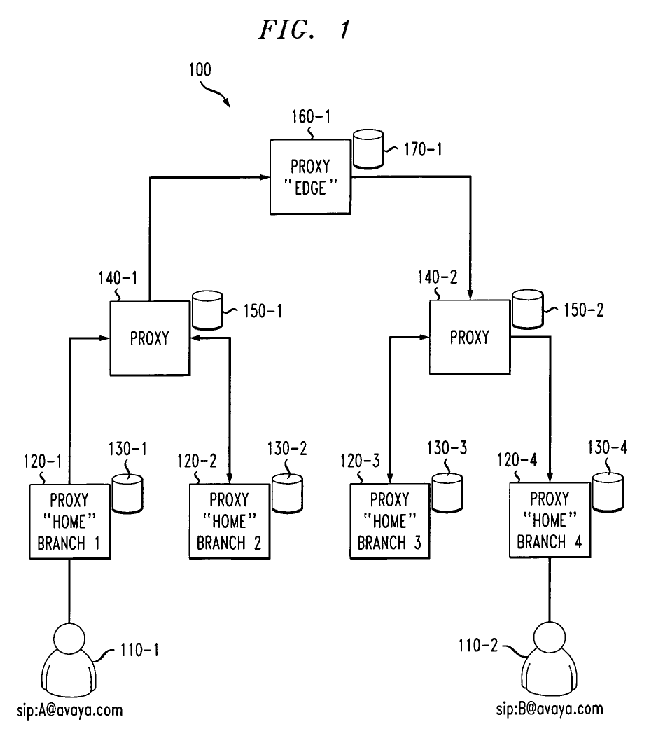

FIG. 1 illustrates an exemplary network environment 100 in which the present invention can operate. Assume an exemplary user A 110-1 is attempting to contact a second exemplary user 110-2. As shown in FIG. 1, each user 110 has an associated home proxy branch 120-1 through 120-4. In addition, each home proxy branch 120 is connected via one or more proxies 140. The proxies 140 are connected via an edge server 160, in a known manner. Each node 120, 140, 160 in the network 100 has an associated routing database 130, 150, 170, respectively.

For example, assume that user 110-1 at proxy 120-1, wants to call user 110-2 on proxy 120-4. Proxy 120-1 does not have routing data for user 110-2, so proxy 120-1 forwards the request to Proxy 140-1 (which is the parent of Proxy 120-1). Proxy 140-1 also does not have routing data for user 110-2 and forwards the request to Proxy 160-1, which has the routing data for User 110-2. Proxy 160-1, does not route the request directly to user 110-2. Rather, proxy 160-1 issues a 302 final response to Proxy 140-1 containing the routing data for User 110-2. Proxy 140-1, in turn, forwards the 302 final response to Proxy 120-1 (the originator of the SIP request).

Proxy 120-1 then stores and/or updates the routing data for User 110-2 in the database 130-1, and routes the request directly to user 110-2. Thereafter, whenever Proxy 120-1 receives a request for User 110-2, the routing data for User 110-2 will be stored in the database 130-1, and proxy 120-1 can directly reach User 110-2 without having to traverse the entire set of SIP servers between Proxy 120-1 and Proxy 160-1 (in order to route the request to user 110-2).

In one exemplary implementation, the present invention employs the 302 final response mechanism to dynamically collect, store and update routing data at the database 130, 150, 170 of a SIP server 120, 140, 160 for a user that is on a remote SIP server in the network 100.

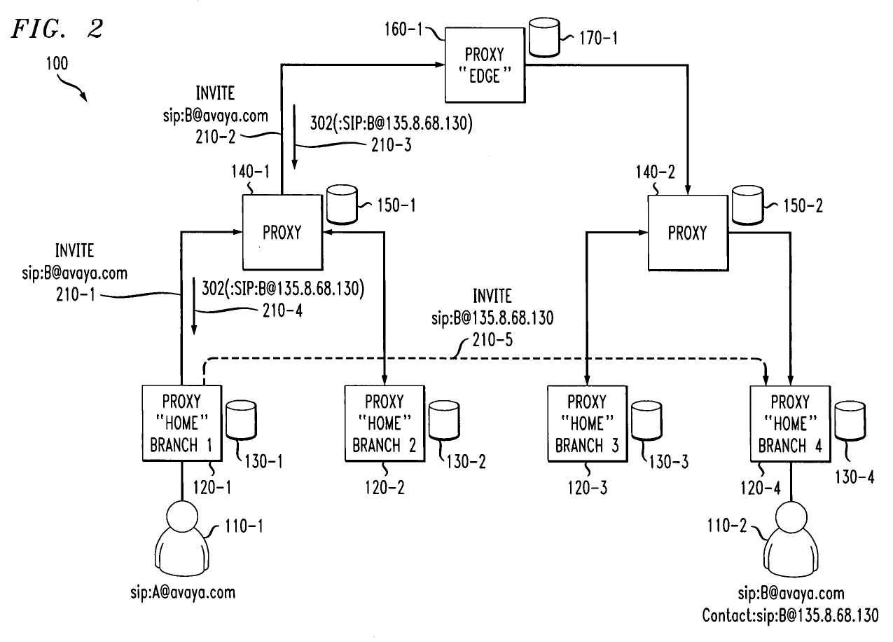

FIG. 2 illustrates the flow of information in the exemplary network environment 100 of FIG. 1 according to an exemplary implementation of the present invention. Assume again that user 110-1 at proxy 120-1, wants to call user 110-2 on proxy 120-4 and indicates this by issuing a SIP invite message. Proxy 120-1 does not initially have routing data for user 110-2 in its local database 130-1, so proxy 120-1 forwards the invite message during step 210-1 from User 110-1 to its parent proxy 140-1. Proxy 140-1 also does not have routing data for user 110-2 and forwards the request during step 210-2 to Proxy 160-1, which has the routing data for User 110-2.

The edge proxy 160-1 knows the routing data (i.e., the contact) for User 110-2. The edge proxy 160-1 finalizes the invite request during step 210-3 with a 302 final response sent to the node 140-1 containing the contact information for User 110-2 (sip:B@135.8.68.130), which the proxy 160-1 obtains from its local database 170-1. Proxy 140-1, in turn, forwards the 302 final response during step 210-4 to Proxy 120-1 (the originator of the SIP request).

Proxy 120-1 then stores and/or updates the routing data for User 110-2 in the database 130-1, and directly routes the invite request during step 210-5 to the proxy 120-4 associated with user 110-2. Thereafter, whenever Proxy 120-1 receives a request for User 110-2, the routing data for User 110-2 will be stored in the database 130-1, and proxy 120-1 can directly reach User 110-2 via proxy 120-4 without having to traverse the entire set of SIP servers between Proxy 120-1 and Proxy 160-1 (in order to route the request to user 110-2).

If User 110-2 moves from proxy branch 120-4 to another branch, then branch 120-4 will return a 404 “User Not Found” response to the invite message from the branch proxy 120-1. In this case, the home branch proxy 120-1 will re-issue the invite request upward towards the edge node 160-1, which will return the new contact for the user 110-2 that has moved. The database of the branch proxy 120-1 will then be updated with the new correct contact for User 110-2.

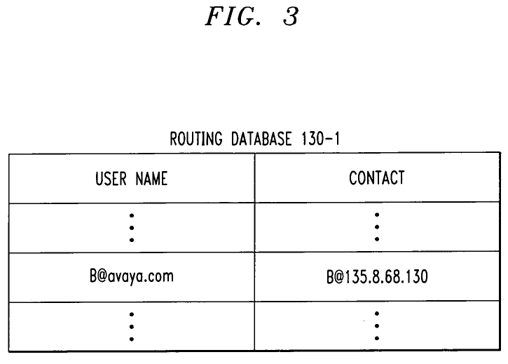

FIG. 3 is a sample table for an exemplary routing database 130-1 maintained by the branch proxy 120-1. As previously indicated, the routing database 130-1 maintained by the branch proxy 120-1 will contain contact information for any users that were previously accessed by the particular SIP server 120-1. As shown in FIG. 1, for each user, the exemplary routing database 130-1 indicates the user name (or the public address sip:B(avaya.com) and SIP contact information (e.g., sip:B@135.8.68.130) for the user.

In this manner, the present invention allows the database of each SIP server to be efficiently maintained. The database of a given SIP server will contain only routing data for users that were previously accessed by the particular SIP server. Thus, for example, if a SIP server only had to route requests to 10,000 users (out of 500,000 potential subscribers), then the database of the SIP server would contain only data for those 10,000 users that were previously accessed by the SIP server. The data set is thereby established dynamically, based on usage.

According to another aspect of the invention, the database of each SIP server is updated and maintained in real-time. Any changes to the routing data for a specific user do not need to be broadcast (or pushed) to every individual SIP server in the network 100. The change in routing data will be discovered dynamically at run time and will be updated at run time.

The present invention provides a less complex administration system because the system does not need to push all the routing data to all SIP servers in the network 100. In addition, the present invention does not have to provide a mechanism to make sure that all the stored data is up to date at all SIP servers in the network 100.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

1. A method for generating a routing database in a network, comprising:
receiving a request message from a first user to contact a second user;
forwarding said request message to a parent node in said network;
receiving a message from said parent node containing a contact address for said second user; and
storing said contact address for said second user in said routing database.

2. The method of claim 1, further comprising the step of forwarding said request message to a node associated with said second user based on said received contact address.

3. The method of claim 2, further comprising the step of obtaining an updated address for said second user from a parent node if a failure message is received from said node associated with said second user.

4. The method of claim 1, wherein said request message is an invite message

5. The method of claim 1, wherein said network is comprised of a plurality of SIP nodes

6. The method of claim 1, wherein said message received from said parent node containing a contact address is a redirect message

7. A method for generating a routing database in a network, comprising:
receiving a request message from a node associated with a first user to contact a second user;
obtaining a contact address for said second user; and
forwarding a message containing said contact address for said second user to said node associated with said first user

8. The method of claim 7, further comprising the step of forwarding said request message to a node associated with said second user based on said obtained contact address.

9. The method of claim 7, wherein said request message is an invite message

10. The method of claim 7, wherein said network is comprised of a plurality of SIP nodes.

11. A system for generating a routing database in a network, comprising:
a memory; and
at least one processor, coupled to the memory, operative to:
receive a request message from a first user to contact a second user;
forward said request message to a parent node in said network;
receive a message from said parent node containing a contact address for said second user; and
store said contact address for said second user in said routing database

12. The system of claim 11, wherein said processor is further configured to forward said request message to a node associated with said second user based on said received contact address.

13. The system of claim 12, wherein said processor is further configured to obtain an updated address for said second user from a parent node if a failure message is received from said node associated with said second user.

14. The system of claim 11, wherein said request message is an invite message

15. The system of claim 11, wherein said network is comprised of a plurality of SIP nodes

16. The system of claim 11, wherein said message received from said parent node containing a contact address is a redirect message

17. A system for generating a routing database in a network, comprising:
a memory; and
at least one processor, coupled to the memory, operative to:
receive a request message from a node associated with a first user to contact a second user;
obtain a contact address for said second user; and
forward a message containing said contact address for said second user to said node associated with said first user

18. The system of claim 17, wherein said processor is further configured to forward said request message to a node associated with said second user based on said obtained contact address

19. The system of claim 17, wherein said request message is an invite message

20. The system of claim 17, wherein said network is comprised of a plurality of SIP nodes.

21. The method of claim 1, wherein said contact address for said second user is stored in said routing database for future use

22. The system of claim 11, wherein said contact address for said second user is stored in said routing database for future use.
